(19) United States
(12) Patent Application Publication
(10) Pub. No.: US 2013/0230764 A1
(43) Pub. Date: Sep. 5, 2013

(54) METHOD OF MANUFACTURING HEADER FOR LITHIUM BATTERY USING POLYMER AND HEADER FOR LITHIUM BATTERY MANUFACTURED BY THE SAME

(71) Applicants: Sang-Sun PARK, Yesan-gun (KR); Ji-Hui YOUN, Seosan-si (KR); Bum-Soo KIM, Cheonan-si (KR)

(72) Inventors: Sang-Sun PARK, Yesan-gun (KR); Ji-Hui YOUN, Seosan-si (KR); Bum-Soo KIM, Cheonan-si (KR)

(73) Assignee: VITZROCELL CO., LTD., Seoul (KR)

(21) Appl. No.: 13/445,583

(22) Filed: Apr. 12, 2012

(30) Foreign Application Priority Data
Mar. 2, 2012 (KR) 10-2012-0021644

(51) Int. Cl. H01M 2/04; B29C 39/10; H01M 2/30

(52) U.S. Cl. 429/176; 429/179; 264/272.15

(57) ABSTRACT

The present disclosure provides a method of simply manufacturing a header for lithium batteries using a polymer, and a header for lithium batteries manufactured by the same. The method includes securing a body having a hole inside dies and securing a cathode pin in the hole so as not to contact the body, filling the hole with polymer powder, and heating the dies to melt the polymer powder, followed by cooling and curing the melted polymer.

### CROSS-REFERENCE TO RELATED APPLICATION

This application claims the benefit under 35 U.S.C. §119 of Korean Patent Application No. 10-2012-0021644, filed on Mar. 2, 2012 in the Korean Intellectual Property Office, the entirety of which disclosure is incorporated herein by reference.

### BACKGROUND

1. Technical Field

The present invention relates to lithium batteries, and more particularly, to a method of manufacturing a header for lithium batteries more simply than a glass fusion bonding method, and a header for lithium batteries manufactured by the same.

2. Description of the Related Art

A lithium battery refers to a battery that uses a lithium component such as lithium or a lithium alloy as an anode material.

Such lithium batteries have higher power and higher capacity than existing manganese batteries and are widely used as power sources for various electronic appliances.

FIG. 1 schematically shows a general lithium battery.

Referring to FIG. 1, a lithium battery includes a case 110 open at top thereof, an anode 120, a separator 130, a cathode 140, and a header.

The anode 120 is placed inside the case 110 and includes a lithium component.

The separator 130 is disposed inside the anode 120 and separates the anode 120 from the cathode 140.

The cathode 140 is disposed inside the separator 130 and includes a current collector 145 and a cathode active material.

The header covers the top of the header. The header includes a body 150a serving as an anode terminal, a cathode pin 150b serving as a cathode terminal, and an insulator 150c electrically insulating the body 150a from the cathode pin 150b. Generally, the body 150a is connected to the anode through the case 110. The anode pin 150b is connected to the current collector 145 of the cathode 140 through a lead wire 160.

An insulating plate 170 insulates the header from elements inside the case. The insulating plate 170 may be made of fluorinated ethylene propylene (FEP) or the like.

FIG. 2 shows a general header structure for lithium batteries, and FIG. 3 is a plan view of the header shown in FIG. 2.

Referring to FIGS. 2 and 3, the header for lithium batteries includes a body 210 defining a hole therein, a cathode pin 220 placed in the hole, and an insulator 230 holding the cathode pin 220 while electrically insulating the body 210 from the cathode pin 220.

The body 210 is coupled to the case 110 (see FIG. 1) and may serve as an anode terminal The cathode pin 220 is electrically connected to the current collector 145 (see FIG. 1) of the cathode. The body 210 and the cathode pin 220 are made of metal.

For operation of the lithium battery, the body 210 and the cathode pin 220 must be electrically insulated from each other. For this reason, the insulator 230 is formed between the body 210 and the cathode pin 220. Also, the insulator 230 serves not only to seal the interior of the lithium battery, but also to hold the cathode pin 220.

The insulator 230 is generally formed by a glass fusion bonding method.

However, the glass fusion bonding method includes a glass melting process and a glass cooling process, and thus requires long time to manufacture the header, thereby lowering productivity.

Korean Patent Publication No. 10-2011-0106506 (published on Sep. 29, 2011) discloses such a conventional header for lithium batteries, which is formed through glass fusion bonding.

### BRIEF SUMMARY

The present invention provides a method of manufacturing a header for lithium batteries, which may shorten a manufacturing time as compared with a glass fusion bonding method.

In addition, the present invention provides a header for lithium batteries manufactured by the foregoing method.

Further, the present invention provides a lithium battery including the header.

In accordance with one aspect of the present invention, a method of manufacturing a header for lithium batteries includes: securing a body having a hole inside dies, and securing a cathode pin in the hole so as not to contact the body; filling the hole with polymer powder; and heating the dies to melt the polymer powder, followed by cooling and curing the melted polymer.

In accordance with another aspect of the present invention, a method of manufacturing a header for lithium batteries includes: securing a body having a hole inside dies, and securing a cathode pin in the hole so as not to contact the body; filling the hole with a liquid polymer; and curing the polymer filling the hole.

In accordance with a further aspect of the present invention, a header for lithium batteries includes: a body having a hole; a cathode pin formed inside the hole and separated from the body; and an insulator formed of a polymer within the hole and electrically insulating the body from the cathode pin.

In accordance with yet another aspect of the present invention, a lithium battery includes: a case open at a top thereof; an anode disposed on an inner wall of the case and containing a lithium component; a separator disposed inside the anode; a cathode disposed inside the separator; an electrolyte filling the case; and a header coupled to the top of the case and electrically connected to the anode and the cathode, the header comprising: a body having a hole and electrically connected to the anode; a cathode pin formed inside the hole to be separated from the body and electrically connected to the cathode; and an insulator formed of a polymer within the hole and electrically insulating the body from the cathode pin.

The header may be coupled to the case by laser welding.

According to the present invention, the method of manufacturing a header for lithium batteries uses a polymer, so that it can be easier and take less time to manufacture the header for lithium batteries than the conventional glass fusion bonding method.

In addition, the manufactured header is coupled to a case of a lithium battery by laser welding, thereby providing improved sealing effects.

### BRIEF DESCRIPTION OF THE DRAWINGS

The above and other aspects, features, and advantages of the invention will become apparent from the detailed description of the following embodiments in conjunction with the accompanying drawings, in which:

FIG. 1 is a schematic view of a general lithium battery;

FIG. 2 shows a general header structure for the lithium battery;

FIG. 3 is a plan view of the header for lithium batteries shown in FIG. 2;

FIG. 4 shows a method of manufacturing a header for lithium batteries in accordance with one embodiment of the present invention, which uses polymer powder;

FIG. 5 shows a method of manufacturing a header for lithium batteries in accordance with another embodiment of the present invention, which uses a liquid polymer; and

FIG. 6 shows a header structure in accordance with one embodiment of the present invention.

### DETAILED DESCRIPTION

Embodiments of the invention will now be described in detail with reference to the accompanying drawings. It should be understood that the present invention is not limited to the following embodiments and may be embodied in different ways, and that the embodiments are given to provide complete disclosure of the invention and to provide thorough understanding of the invention to those skilled in the art. The scope of the invention is limited only by the accompanying claims and equivalents thereof. Like components will be denoted by like reference numerals throughout the specification.

Now, a method of manufacturing a header for lithium batteries using polymer in accordance with the present invention and a header for lithium batteries manufactured by the method will be described with reference to the accompanying drawings.

FIG. 4 shows a method of manufacturing a header for lithium batteries in accordance with one embodiment of the present invention.

Referring to FIG. 4, the method of manufacturing a header for lithium batteries includes securing a body/cathode pin in S410, filling polymer powder in S420, and melting/curing the polymer in S430.

In operation S410 of securing a body/cathode pin, a body having a hole is secured inside dies and a cathode pin is secured inside the hole so as not to contact the body.

The body may be previously manufactured in a header shape, or may be formed to have a header shape by the dies.

Next, in operation S420 of filling a polymer powder, the hole is filled with the polymer powder.

The polymer may include butyl rubbers, silicon rubbers or butadiene rubbers, which exhibit excellent properties in terms of strength and sealing properties, without being limited thereto as long as the polymer has insulation properties.

To enhance sealing and coupling properties, the polymer powder may be provided not only to the hole, but also to a space between the dies and parts of the top and bottom of the body.

Next, in operation S430 of melting/curing the polymer, the polymer inside the hole is melted by heating the dies, and cooled and cured. At this time, the curing process may include a drying process.

When these operations described above are completed, the header for lithium batteries as shown in FIG. 6 may be provided.

Although the method illustrated as using the polymer powder in FIG. 4, a liquid polymer may be used instead of the polymer powder.

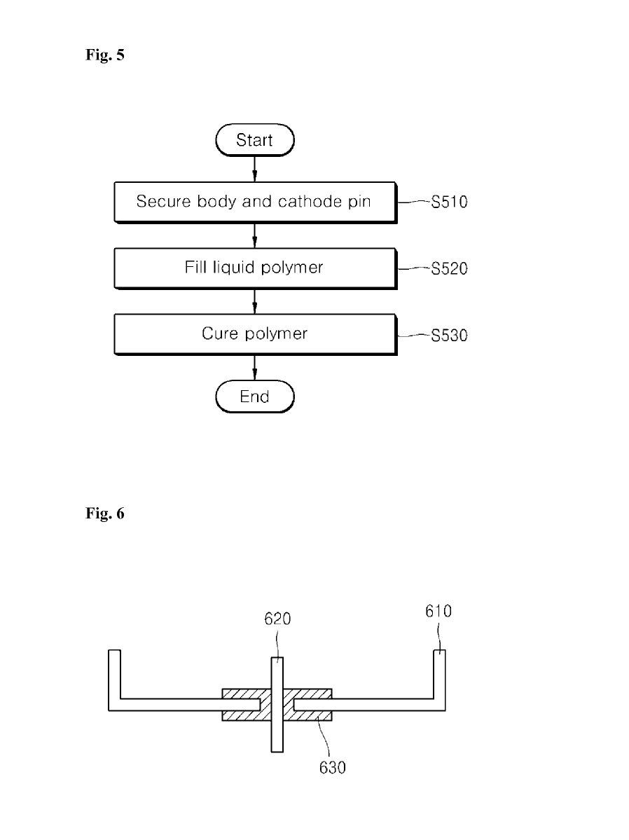

FIG. 5 shows a method of manufacturing a header for lithium batteries in accordance with another embodiment of the present invention, which uses a liquid polymer.

Referring to FIG. 5, the method of manufacturing a header for lithium batteries includes securing a body/cathode pin in S510, injecting a liquid polymer in S520, and curing the polymer in S530.

In operation S510 of securing a body/cathode pin, a body having a hole is secured inside dies, and a cathode pin is secured inside the hole so as not to contact the body. The body may be previously subjected to a masking process except for a region corresponding to the interior of the hole which will receive the liquid polymer.

Next, in operation S520 of injecting a liquid polymer, the liquid polymer is injected into the dies such that the hole is filled with the liquid polymer.

Here, the liquid polymer may be a polymer in a liquid state, or a polymer containing solution.

To enhance sealing and coupling properties, the liquid polymer may be provided not only to the hole, but also to a space between the dies and parts of the top and bottom of the body.

Next, in operation S530 of curing the polymer, the polymer inside the hole is hardened. At this time, curing may include a drying process.

Curing may be determined in accordance with the kinds of polymer. For example, in order to cure the polymer, heating may be applied to thermosetting polymers, and ultraviolet light may be applied to UV-setting polymers.

When these operations described above are completed, the header for lithium batteries as shown in FIG. 6 may be provided.

FIG. 6 shows a header structure in accordance with one embodiment of the present invention.

Referring to FIG. 6, the header for lithium batteries includes a body 510, a cathode pin 520, and an insulator 530.

In the header for lithium batteries, the body 510 covers the top of a case and functions as an anode terminal The body 510 may be made of a material such as stainless steel, which exhibits excellent properties in terms of durability and conductivity.

The body 510 is formed with a hole for forming the cathode pin 520.

The cathode pin 520 is formed inside the hole to be separated from the body 510. In the header, the cathode pin 520 functions as a cathode terminal and may also be made of a material such as stainless steel, which exhibits excellent properties in terms of durability and conductivity.

The insulator 530 is made of a polymer within the hole. The insulator 530 electrically insulates the body 510 from the cathode pin 520. Further, the insulator 530 holds the cathode pin 520 and seals the hole. Accordingly, the insulator may be composed of butyl rubbers, silicon rubbers or butadiene rubbers, which exhibit excellent properties in terms of strength and sealing properties.

The body 510 may be partially provided at the top and bottom thereof with the insulator 530, as shown in FIG. 6. In this case, coupling and sealing properties may be further improved with increasing coupling area between the insulator 530 and the body 510.

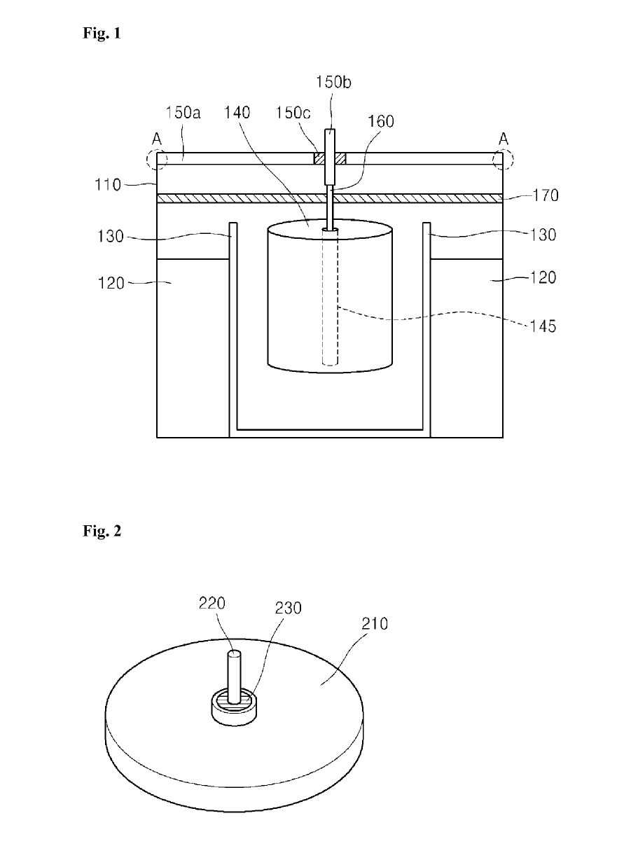

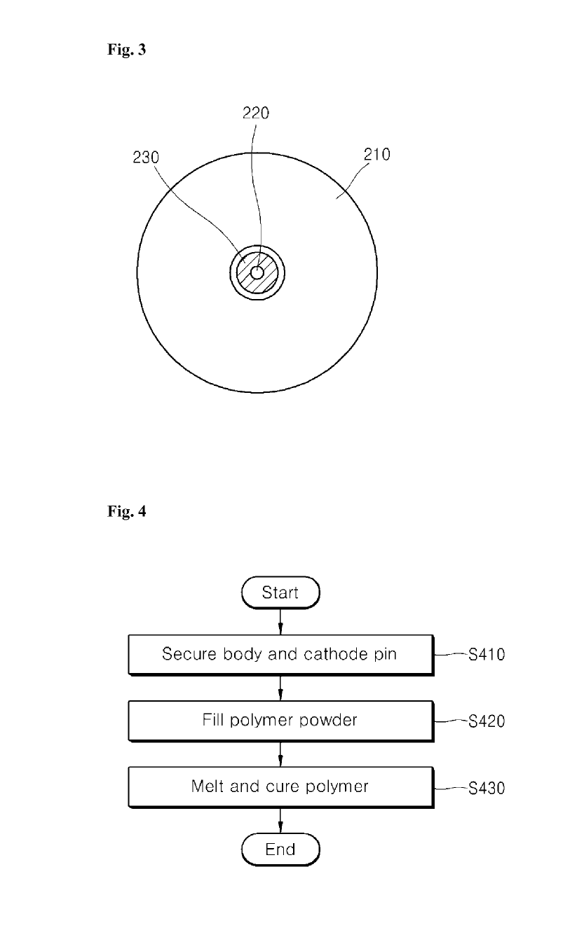

The header according to the present invention may be used for a lithium battery as shown in FIG. 1.

In this case, the lithium battery in accordance with the present invention includes a case 110, a cathode 120, a separator 130, an anode 140, an electrolyte (not shown), and the header.

The case 110 is made of stainless steel or the like, and is open at the top thereof. The anode 120 is disposed on an inner wall of the case 110 and contains a lithium component. The separator 130 is disposed inside the anode 120. The cathode 140 is disposed inside the separator 130. The electrolyte (not shown) fills the case. The header is coupled to the top of the case 110 and is electrically connected to the anode 120 and the cathode 140.

The header according to the present invention includes the body 510, the cathode pin 520, and the insulator 530. The insulator 530 for electrically insulating the body 510 from the cathode pin 520 may be formed of a polymer and formed by injection molding.

In FIG. 1, part “A” shows a coupling part between the header and the case. The header may be coupled to the case 110 by laser welding.

Conventionally, press-fitting or gasket-insertion between the header and the case is used for sealing the battery when coupling the header and the case. However, such a conventional battery provides unsatisfactory sealing-properties.

On the other hand, when the header and the case are coupled to each other by laser welding, the battery has good sealing-properties. Therefore, it is desirable that the header be coupled to the case by laser welding.

As described above, the method of manufacturing the header for lithium batteries in accordance with the present invention uses injection-molding of a polymer, so that it can be easier and take less time to manufacture the header for lithium batteries than the conventional glass fusion bonding method. Also, the manufactured header is coupled to the case by laser welding, thereby providing improved sealing effects.

Although some embodiments have been described herein, it should be understood by those skilled in the art that these embodiments are given by way of illustration only, and that various modifications, variations, and alterations can be made without departing from the spirit and scope of the invention. Therefore, the scope of the invention should be limited only by the accompanying claims and equivalents thereof.

What is claimed is:

1. A method of manufacturing a header for lithium batteries, comprising:
securing a body having a hole inside dies, and securing a cathode pin in the hole so as not to contact the body;
filling the hole with polymer powder; and
heating the dies to melt the polymer powder, followed by cooling and curing the melted polymer.

2. The method of claim 1, wherein the polymer powder is provided to parts of a top and bottom of the body.

3. The method of claim 1, wherein the polymer powder comprises at least one selected from among a butyl rubber, a silicone rubber and a butadiene rubber.

4. A method of manufacturing a header for lithium batteries, comprising:
securing a body having a hole inside dies, and securing a cathode pin in the hole so as not to contact the body;
filling the hole with a liquid polymer; and
curing the polymer filling the hole.

5. The method of claim 4, wherein the liquid powder is provided to parts of a top and bottom of the body.

6. The method of claim 4, wherein the polymer powder comprises at least one selected from among a butyl rubber, a silicone rubber and a butadiene rubber.

7. A header for lithium batteries comprising:
a body having a hole;
a cathode pin formed inside the hole to be separated from the body; and
an insulator formed of a polymer within the hole and electrically insulating the body from the cathode pin.

8. The header of claim 7, wherein the insulator comprises at least one selected from among a butyl rubber, a silicone rubber and a butadiene rubber.

9. The header of claim 7, wherein the body is partially provided at the top and bottom thereof with the insulator.

10. A lithium battery comprising:
a case open at a top thereof;
an anode disposed on an inner wall of the case and containing a lithium component;
a separator disposed inside the anode;
a cathode disposed inside the separator;
an electrolyte filling the case; and
a header coupled to the top of the case and electrically connected to the anode and the cathode,
the header comprising:
a body having a hole and electrically connected to the anode;
a cathode pin formed inside the hole to be separated from the body and electrically connected to the cathode; and
an insulator formed of a polymer within the hole and electrically insulating the body from the cathode pin.

11. The lithium battery of claim 10, wherein the header is coupled to the case by laser welding.

12. The lithium battery of claim 10, wherein the insulator comprises at least one selected from among a butyl rubber, a silicone rubber and a butadiene rubber.

13. The lithium battery of claim 10, wherein the body is partially provided at the top and bottom thereof with the insulator.
